(19) United States
(12) Patent Application Publication
(10) Pub. No.: US 2023/0349383 A1
(43) Pub. Date: Nov. 2, 2023

(54) Methods for Judging and Optimizing Comprehensive Performance of Twin-Screw Rotor Profile

(71) Applicant: Jiangnan University, Wuxi (CN)

(72) Inventors: Xueming HE, Wuxi (CN); Rong HU, Wuxi (CN); Jiachuan YU, Wuxi (CN); Junxia YAN, Wuxi (CN); Jianzhong SONG, Wuxi (CN); Weijie SUN, Wuxi (CN); Haigang FAN, Wuxi (CN)

(21) Appl. No.: 18/220,908

(22) Filed: Jul. 12, 2023

Related U.S. Application Data
(63) Continuation of application No. PCT/CN2021/133834, filed on Nov. 29, 2021.

(30) Foreign Application Priority Data
Nov. 25, 2021 (CN) 202111412125.1

(51) Int. Cl. F04C 28/28; F04C 18/16

(52) U.S. Cl. CPC F04C 28/28; F04C 18/16

(57) ABSTRACT

The disclosure discloses a method for judging and optimizing the comprehensive performance of a twin-screw rotor profile, belonging to the field of compressor design and manufacturing. The method determines the relationship among a contact line length, a leakage triangle and an area utilization coefficient of a compressor rotor profile by establishing an expression of a comprehensive performance index of the performance of the compressor rotor profile, so that during the design of the compressor rotor profile, the performance of the designed compressor rotor profile can be judged according to the method, so as to provide a reference index for optimizing the rotor profile, improve the design efficiency of the compressor rotor profile and provide a high-performance rotor profile for producing a high-performance compressor.

### TECHNICAL FIELD

The disclosure relates to methods for judging and optimizing the comprehensive performance of a twin-screw rotor profile, belonging to the field of compressor design and manufacturing.

### BACKGROUND

A twin-screw compressor belongs to a type of volumetric rotary mechanical equipment, composed of a pair of screw rotors (also known as female and male rotors), a pair of end covers and a casing. As a universal machine, the twin-screw compressor is widely used in various industrial sectors such as power and refrigeration due to the characteristics of its structure and performance. Furthermore, the twin-screw compressor also has better adaptability, thereby gradually replacing other types of compressors such as slide vane compressors.

The performance of screw rotors (female and male rotors), as core components of the screw compressor, directly determines the performance of the screw compressor. A rotor profile is a research basis for many problems such as the processing performance of screw rotors and the comprehensive performance of equipment operation (the rotor profile refers to a section line of an axial end plane of a screw rotor), that is, the performance of the rotor profile directly affects the overall performance of the twin-screw compressor. Therefore, researchers and designers of screw rotors conduct research on parameters that affect the performance of the rotor profile, including a contact line length, a leakage triangle area, an area utilization coefficient, an inter-tooth area a closed volume, and the like. From the perspective of leak tightness, the impact of changes in rotor profile on performance parameters is investigated, and change rules of the performance parameters are summarized, thereby providing certain theoretical guidance for optimizing the rotor profile based on a line-of-action method in the future.

The design quality of a screw rotor profile is mainly judged by investigating whether its rotor space volume has excellent leak tightness. The evaluation of the performance of the screw compressor, especially the performance parameters of the rotor profile, is extended based on a line-of-action equation. For main performance parameters, the design principle of the screw rotor profile is to form a shorter and continuous contact line, a smaller leakage triangle, and a larger area utilization coefficient. The performance parameters of the compressor, such as the contact line length, the leakage triangle area and the area utilization coefficient, have different directions of impact on the performance of the compressor, and the parameters will affect each other. For example, when the leakage triangle area is reduced, the contact line length of profiles of female and male rotors may be increased; and when the leakage triangle area is reduced, the area utilization coefficient may be increased. Moreover, at present, the impact of the parameters on the performance of the compressor cannot be quantified, so it is impossible to evaluate the design quality of the rotor profile according to one of the parameters, a sample can only be produced after the rotor profile is designed by experience, and whether the designed rotor profile has better performance is judged according to the produced sample, resulting in low design efficiency and higher cost.

### SUMMARY

In order to solve the problem of low design efficiency caused by inability to judge the design quality of a rotor profile according to one of parameters due to the fact that the performance parameters of a screw compressor have different directions of impact on the performance of the compressor, the disclosure provides methods for judging and optimizing the comprehensive performance of a rotor profile of a twin-screw rotor. The performance of the rotor profile of the twin-screw rotor is determined by providing a comprehensive performance index K, and then, a line of action is divided into eight segments. The adjustment direction and distance of each of the segments are determined by the comprehensive performance index K so as to obtain a high-performance rotor profile, and then, a high-performance compressor is produced according to the obtained high-performance rotor profile.

Provided is a method for optimizing a twin-screw rotor profile. The method includes:

obtaining relevant parameters of female and male rotors of a twin-screw rotor: a contact line length L, a leakage triangle area S, a number of rotor teeth of the female and male rotors, and a tip radius;

computing an area utilization coefficient Cₐ according to the number of rotor teeth of the female and male rotors and the tip radius;

computing a comprehensive performance index K according to Formula (10):

K=aL*bS/(cCₐ) (10),

where a, b and c are coefficients that unify the contact line length L and the area utilization coefficient Cₐ to the order of magnitude of the leakage triangle area S;
determining each point on a line of action of the twin-screw rotor in a clockwise direction to divide the line of action into eight segments, where a point A′ is an intersection point of a tip circle of the female rotor and a root circle of the male rotor, a point B′ is an intersection point of pitch circles of the female and male rotors, a point C′ is a bottom dead center of the line of action, and a point D′ is an intersection point of a tip circle of the male rotor and a root circle of the female rotor; then, dividing an arc A′B′, an arc D′B′ and an arc B′A′ into left and right segments with the lowest point P′ of the arc A′B′, the highest point N′ of the arc D′B′ and the highest point M′ of the arc B′A′ as boundaries;
adjusting the line of action of each of the segments “inside” or “outside” respectively, and determining the adjustment direction and distance of each of the segments by computing the comprehensive performance index K of the twin-screw rotor profile before and after adjustment, where a modification direction that reduces the area enclosed by the line of action is “inside”, otherwise it is “outside”; and
determining a twin-screw rotor profile with a minimum comprehensive performance index K, namely an optimized twin-screw rotor profile, based on the adjustment direction and distance of each of the segments, so as to facilitate the subsequent preparation of a screw rotor of a screw compressor according to the optimized twin-screw rotor profile.

Optionally, the smaller a value of the comprehensive performance index K of the twin-screw rotor profile, the better the performance of the compressor produced according to the corresponding rotor profile.

Optionally, the determining the adjustment direction and distance of each of the segments by computing a comprehensive performance index K of the twin-screw rotor profile before and after adjustment includes:
if a value of the comprehensive performance index K of the twin-screw rotor profile after adjustment is less than a value before adjustment, continuing to perform adjustment in the current direction until the value of the comprehensive performance index K reaches an inflection point; and
if the value of the comprehensive performance index K of the twin-screw rotor profile after adjustment is greater than the value before adjustment, performing adjustment in the opposite direction until the value of the comprehensive performance index K reaches an inflection point.

The inflection point refers to a point changing the direction of a curve corresponding to the value of the comprehensive performance index K of the twin-screw rotor profile.

Optionally, the computing an area utilization coefficient Cₐ according to the number of rotor teeth of the female and male rotors and the tip radius includes:
computing an inter-tooth area A₀₂ and an inter-tooth area A₀₁ of the female and male rotors respectively, where the inter-tooth area refers to an area of a projection of a relatively closed cell volume formed between helical tooth flanks of the female and male rotors and a casing on a rotor end plane when the two rotors rotate and mesh; and
computing the area utilization coefficient Cₐ according to Formula (9):

$${C}_{α} = \frac{{z}_{1} ( {A}_{01} + {A}_{02} )}{{D}_{1}^{2}} , \qquad ( 9 )$$

where D₁ represents a tip diameter of the male rotor, and z₁ represents a number of teeth of the male rotor.

Optionally, when the units of the contact line length L, the number of rotor teeth of the female and male rotors and the tip radius are millimeter and the unit of the leakage triangle area S is square millimeter, values of a, b and c are respectively:
a=0.01, b=1, c=10.

Optionally, when obtaining the contact line length L, the method includes:

establishing a three-dimensional coordinate system with an axial center of an end plane of the male rotor as an origin O, a direction pointing to an axial center of the female rotor as an Xaxis, an axial direction as a Z axis, and a Yaxis perpendicular to an XOZ plane; and

discretizing the contact line into m points, and computing the contact line length L according to Formula (1):

$$L = {\sum }_{n = 1}^{𝔪} \sqrt{{( {x}_{n} - {x}_{n - 1} )}^{2} + {( {y}_{n} - {y}_{n - 1} )}^{2} + {( {z}_{n} - {z}_{n - 1} )}^{2}} , \qquad ( 1 )$$

where n represents a subscript of each of the discrete points, n=1, 2, . . . , m, and xₙ, yₙ and zₙ represent three-dimensional coordinates of each of the discrete points.

Optionally, when obtaining the leakage triangle area S, the method includes:
setting a point A as an intersection point between a tooth flank of the male rotor and an intersection line WW of an inner wall surface of a casing, a point B as an intersection point between a tooth flank of the female rotor and the intersection line WW of the inner wall surface of the casing, and a point C as the highest point of the contact line of the twin-screw rotor, where the contact line is a curve formed in space by a contact part between two helical tooth flank when the female and male rotors mesh;
discretizing curves AC and BC into p points and q points respectively; and
setting points Mᵢ and Fⱼ as discrete points on the curves AC and BC respectively and the distances between the points Mᵢ and Fⱼ and the intersection line WW as W̅M̅ᵢ and W̅F̅ⱼ respectively, obtaining:

$$Δ {S}_{{ACW}_{c}} = {\sum }_{i = 1}^{p} \frac{\overline{AB}}{p} \cdot \overline{{WM}_{ι}} , \qquad ( 3 )$$

$${ΔS}_{{BCW}_{c}} = {\sum }_{j = 1}^{q} \frac{\overline{{BW}_{C}}}{q} \cdot \overline{{WF}_{J}} , \qquad ( 4 )$$

and obtaining the leakage triangle area S:

$$S = Δ {S}_{ABC} = {\sum }_{i = 1}^{p} \frac{\overline{AB}}{p} \cdot \overline{{WM}_{ι}} - {\sum }_{j = 1}^{q} \frac{\overline{{BW}_{C}}}{q} \cdot \overline{{WF}_{J}} , \qquad ( 5 )$$

where A̅B̅ represents an edge projected onto the intersection line WW by a curved edge AB of a spatial curved edge leakage triangle, and B̅W̅_{c} represents a distance between a projection point of the highest point of the contact line on the intersection line WW and the point B.

Optionally, the line of action is a projection of the contact line on an axial end plane of the rotor.

Optionally, the area enclosed by the line of action refers to an area of a closed region enclosed by the line of action.

This application further provides a method for judging the comprehensive performance of a twin-screw rotor profile. The method includes:
obtaining relevant parameters of female and male rotors of a twin-screw rotor: a contact line length L, a leakage triangle area S, a number of rotor teeth of the female and male rotors, and a tip radius;
computing an area utilization coefficient Cₐ according to the number of rotor teeth of the female and male rotors and the tip radius;
computing a comprehensive performance index K according to Formula (10):

K=aL*bS/(cCₐ) (10),

where a, b and c are coefficients that unify the contact line length L and the area utilization coefficient Cₐ to the order of magnitude of the leakage triangle area S; and
judging the performance of the twin-screw rotor profile according to the computed value of the comprehensive performance index K.

Optionally, when the units of the contact line length L, the number of rotor teeth of the female and male rotors and the tip radius are millimeter and the unit of the leakage triangle area S is square millimeter, values of a, b and c are respectively:
a=0.01, b=1, c=10.

Optionally, the computing an area utilization coefficient Cₐ according to the number of rotor teeth of the female and male rotors and the tip radius includes:
computing an inter-tooth area A₀₂ and an inter-tooth area A₀₁ of the female and male rotors respectively, where the inter-tooth area refers to an area of a projection of a relatively closed cell volume formed between helical tooth flanks of the female and male rotors and a casing on a rotor end plane when the two rotors rotate and mesh; and
computing the area utilization coefficient Cₐ according to Formula (9):

$${C}_{α} = \frac{{z}_{1} ( {A}_{01} + {A}_{02} )}{{D}_{1}^{2}} , \qquad ( 9 )$$

where D₁ represents a tip diameter of the male rotor, and z₁ represents a number of teeth of the male rotor.

Optionally, when obtaining the contact line length L, the method includes:
establishing a three-dimensional coordinate system with an axial center of an end plane of the male rotor as an origin O, a direction pointing to an axial center of the female rotor as an Xaxis, an axial direction as a Z axis, and a Yaxis perpendicular to an XOZ plane; and
discretizing the contact line into m points, and computing the contact line length L according to Formula (1):

$$L = {\sum }_{n = 1}^{m} \sqrt{{( {x}_{n} - {x}_{n - 1} )}^{2} + {( {y}_{n} - {y}_{n - 1} )}^{2} + {( {z}_{n} - {z}_{n - 1} )}^{2}} , \qquad ( 1 )$$

where n represents a subscript of each of the discrete points, n=1, 2, . . . , m, and xₙ, yₙ and zₙ represent three-dimensional coordinates of each of the discrete points.

Optionally, when obtaining the leakage triangle area S, the method includes:
setting a point A as an intersection point between a tooth flank of the male rotor and an intersection line WW of an inner wall surface of a casing, a point B as an intersection point between a tooth flank of the female rotor and the intersection line WW of the inner wall surface of the casing, and a point C as the highest point of the contact line of the twin-screw rotor, where the contact line is a curve formed in space by a contact part between two helical tooth flanks when the female and male rotors mesh;
discretizing curves AC and BC into p points and q points respectively; and
setting points Mᵢ and Fⱼ as discrete points on the curves AC and BC respectively and the distances between the points Mᵢ and Fⱼ and the intersection line WW as W̅M̅ᵢ and W̅F̅ⱼ respectively, obtaining:

$$Δ {S}_{{ACW}_{C}} = {\sum }_{i = 1}^{p} \frac{\overline{AB}}{p} \cdot \overline{{WM}_{ι}} , \qquad ( 3 )$$

$$Δ {S}_{{BCW}_{C}} = {\sum }_{j = 1}^{q} \frac{\overline{{BW}_{C}}}{q} \cdot \overline{{WF}_{}} , \qquad ( 4 )$$

and obtaining the leakage triangle area S:

$$S = Δ {S}_{ABC} = {\sum }_{i = 1}^{p} \frac{\overline{AB}}{p} \cdot \overline{{WM}_{ι}} - {\sum }_{j = 1}^{q} \frac{\overline{{BW}_{C}}}{q} \cdot \overline{{WF}_{}} , \qquad ( 5 )$$

where A̅B̅ represents an edge projected onto the intersection line WW by a curved edge AB of a spatial curved edge leakage triangle, and B̅W̅_{c} represents a distance between a projection point of the highest point of the contact line on the intersection line WW and the point B.

The disclosure has the following beneficial effects:

The relationship among the contact line length, the leakage triangle and the area utilization coefficient of a compressor rotor profile is determined by establishing an expression of the comprehensive performance index of the compressor rotor profile, so that during the design of the compressor rotor profile, the performance of the designed compressor rotor profile can be judged according to the method, so as to improve the design efficiency of the compressor rotor profile and provide a high-performance rotor profile for producing a high-performance compressor.

### BRIEF DESCRIPTION OF FIGURES

In order to more clearly illustrate the technical solutions in the examples of the disclosure, the accompanying drawings required for description of the examples will be briefly introduced below. It is apparent that the accompanying drawings in the following description are only some examples of the disclosure. Those of ordinary skill in the art can also obtain other drawings according to these accompanying drawings without creative efforts.

FIG. 1A shows a view of screw rotor profiles and elements thereof, where 1 represents a male rotor profile, 2 represents a female rotor profile, 3 represents a closed volume, 4 represents a line of action, 6 represents an rotor space volume of a male rotor, 7 represents a pitch circle of the male rotor, 8 represents a pitch circle of a female rotor, 9 represents an rotor space volume of the female rotor, 11 represents an inner wall of a casing, and W represents a projection point of an intersection line of cylindrical surfaces on the inner wall of the casing.

FIG. 1B shows an enlarged view of a closed volume and a line of action of a screw rotor.

FIG. 1C shows an axial view of a leakage triangle and a contact line of a screw rotor, where 5 represents the leakage triangle, and 10 represents the contact line.

FIG. 2A shows a schematic view of relationship between a contact line and a line of action of a compressor rotor.

FIG. 2B shows a view of a line of action of a compressor rotor.

FIG. 3 shows a schematic view of a spatial position of a leakage triangle.

FIG. 4 shows a schematic view of computation of a leakage triangle.

FIG. 5 shows a view of a Fusheng line of action after segmenting.

FIG. 6A shows a view of inward movement of a segment A′M′ of a line of action.

FIG. 6B shows a view of outward movement of the segment A′M′ of the line of action.

FIG. 7A shows a view of inward movement of a segment M′B′ of a line of action.

FIG. 7B shows a view of outward movement of the segment M′B′ of the line of action.

FIG. 8A shows a view of inward movement of a segment B′C′ of a line of action.

FIG. 8B shows a view of outward movement of the segment B′C′ of the line of action.

FIG. 9A shows a view of inward movement of a segment C′D′ of a line of action.

FIG. 9B shows a view of outward movement of the segment C′D′ of the line of action.

FIG. 10A shows a view of inward movement of a segment D′N′ of a line of action.

FIG. 10B shows a view of outward movement of the segment D′N′ of the line of action.

FIG. 11A shows a view of inward movement of a segment N′B′ of a line of action.

FIG. 11B shows a view of outward movement of the segment N′B′ of the line of action.

FIG. 12A shows a view of inward movement of a segment B′P′ of a line of action.

FIG. 12B shows a view of outward movement of the segment B′P′ of the line of action.

FIG. 13A shows a view of inward movement of a segment P′A′ of a line of action.

FIG. 13B shows a view of outward movement of the segment P′A′ of the line of action.

FIG. 14 shows a view of an optimization direction of each segment of a line of action.

### DETAILED DESCRIPTION

In order to make the objectives, technical solutions and advantages of the disclosure clearer, the implementations of the disclosure will be further described in detail below with reference to the accompanying drawings.

Contact line: A curve formed in space by a contact part between two helical tooth flanks when female and male rotors mesh is referred to as a contact line.

Line of action: A projection of a contact line on an axial end plane of a rotor is referred to as a line of action.

Leakage triangle: A curved edge triangle formed by an intersection line of cylindrical surfaces on an inner wall of a casing and tooth flanks of female and male rotors is referred to as a leakage triangle.

Cell volume: Relatively closed volumes formed between helical tooth flanks of female and male rotors and a casing when the two rotors rotate and mesh are referred to as cell volumes.

Inter-tooth area: An area of a projection of a relatively closed cell volume formed between helical tooth flanks of female and male rotors and a casing on a rotor end plane when the two rotors rotate and mesh is referred to as an inter-tooth area.

Closed volume: A volume formed by tooth profiles of female and male rotors in space when the two rotors rotate is referred to as a closed volume.

Tip circle: An intersection line of cylindrical surfaces of tips of female and male rotors and a transverse plane is referred to as a tip circle.

Rotor profile: A projection of a tooth flank profile of female and male rotors on end planes thereof is referred to as a rotor profile.

The characteristics of a Fusheng rotor profile and a Hitachi rotor profile in common rotor profiles are as follows:

Fusheng rotor profile: The ratio of the number of teeth of female and male rotors is 6:5. The rotor profile is an asymmetrical profile and is composed of four segments of curves. A male rotor is composed of one segment of arc envelope, one segment of elliptical arc and two segments of arcs. A female rotor is composed of one segment of arc, one segment of elliptical arc envelope and two segments of arc envelopes.

Hitachi rotor profile: The ratio of the number of teeth of female and male rotors is 6:5. The rotor profile is an asymmetrical profile and is composed of six segments of curves. A female rotor is composed of four segments of arcs, one segment of pin tooth arc and one segment of tip arc. A male rotor is composed of four segments of arc envelopes, one segment of pin tooth arc envelope and one segment of root arc.

### EXAMPLE 1

This example provides a method for optimizing a twin-screw rotor profile. The method includes the following steps:

Step 1: Computation formulae of parameters related to the comprehensive performance of the rotor profile as well as a contact length L, a leakage triangle area S and an area utilization coefficient M of parameters related to the performance of the rotor profile are determined.

A compressor rotor has multiple profiles, and this example takes a six-time NURBS-fitted Fusheng line of action as an example for illustration.

As described above, a tooth curve of a Fusheng profile is composed of four segments. A female rotor includes two segments of arc envelopes, one segment of elliptical envelope and one segment of arc. A male rotor includes two segments of arcs, one segment of ellipse and one segment of arc envelope. The Fusheng line of action is also composed of four segments of tooth curves, and the Fusheng line of action after segmenting is as shown in FIG. 5.

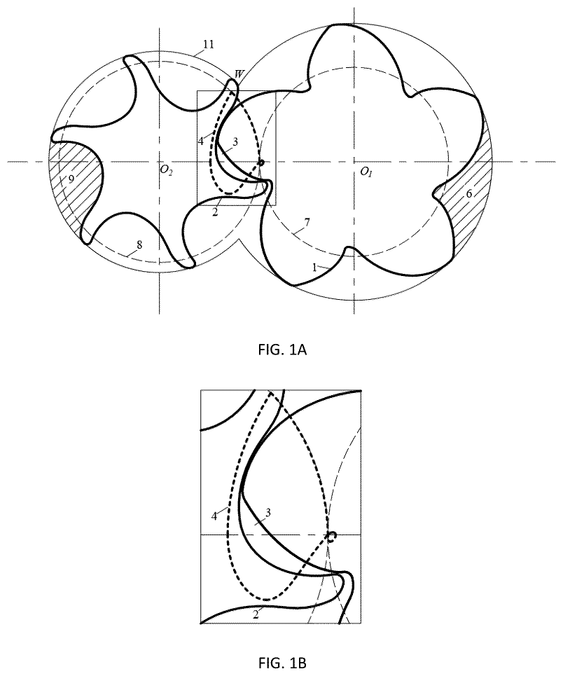

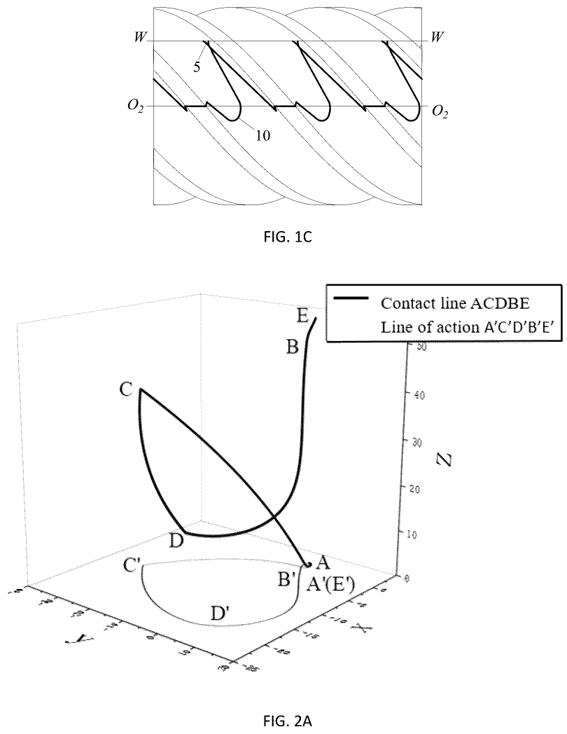

FIG. 1A, FIG. 1B and FIG. 1C show schematic views of screw rotor profiles and elements thereof. FIG. 1A shows rotor profiles, a line of action, inter-tooth areas and a closed volume. FIG. 1B shows an enlarged view of a closed volume and a line of action of a screw rotor. FIG. 1C shows an axial view of a leakage triangle and a contact line.

In FIG. 1A and FIG. 1C, 1 represents a male rotor profile, 2 represents a female rotor profile, 3 represents a closed volume, 4 represents a line of action, 5 represents a leakage triangle, 6 represents an rotor space volume of a male rotor, 7 represents a pitch circle of the male rotor, 8 represents a pitch circle of a female rotor, 9 represents an rotor space volume of the female rotor, 10 represents a contact line, 11 represents an inner wall of a casing, and W represents a projection point of an intersection line of cylindrical surfaces on the inner wall of the casing on an end plane.

When the teeth of the twin-screw rotor mesh with each other, the contact part between two helical tooth flanks forms a special-shaped curve in space, which is referred to as a contact line. The contact line divides the rotor space volume of the female and male rotors into two parts. A medium on one side is in a compressed state, and a medium on the other side is in an inspiratory state, so there is a certain pressure difference in working cavities on both sides of the contact line. One side is referred to as a high-pressure side, and the other side is referred to as a low-pressure side. Therefore, the contact line is also a boundary between the high-pressure side and the low-pressure side of a cell volume, as shown in FIG. 1B. Due to the impact of the thermal load and pressure action on the female and male rotors during operation, close contact may cause slight deformations. In order to avoid interference during rotor meshing to protect the rotors from being damaged, a certain gap is reserved between the tip of the male rotor and the root of the female rotor. Therefore, the contact line in theory is actually a contact line gap band. The gas on the high-pressure side flows to the low-pressure side through the gap band under the pressure action, and this internal transverse leakage will lead to a decrease in volume flow and volume efficiency of the twin-screw compressor, so it is very necessary to improve the sealing effect of the contact line on cell volumes on both sides thereof. On the premise of ensuring an appropriate gap between the female and male rotors to avoid motion interference, reducing the contact line length is an effective method. The volume flow mentioned above refers to the volume of the gas discharged by a compressor in a unit time at the required discharge pressure. The volume efficiency refers to a ratio of the actual volume flow of a compressor to the theoretical volume flow of a working cavity.

Computation of Contact Line Length:

In a computation process of the contact line length, first, a contact line is discretized into a series of points, and then, distances between two adjacent points are accumulated and summed to obtain the contact line length. When a number of discrete points is sufficient, the computation accuracy can be ensured, and the computation process is easy to implement through programming algorithms. The computation process of the contact line length is as follows:

First, a three-dimensional coordinate system is established with an axial center of an end plane of the male rotor as an origin O, a direction pointing to an axial center of the female rotor as an X axis, an axial direction as a Z axis, and a Yaxis perpendicular to an XOZ plane. The formula is as follows:

L=Σₙ₌₁^{m}\sqrt{(xₙ−xₙ₋₁)²+(yₙyₙ₋₁)²+(zₙ−zₙ₋₁)²} (1),

where n represents a subscript of each of the discrete points, m represents the number of the discrete points, and xₙ, yₙ and zₙ represent three-dimensional coordinates of each of the discrete points.

A rotor line of action derived from female and male rotor profiles is an important consideration for judging the performance of the rotor profile, and the line of action is a trajectory of meshing points of the rotor profile. Therefore, it can be seen that the line of action is a projection of the contact line on an axial end plane of the rotor. The relationship between the line of action and the contact line is as shown in FIG. 2A. FIG. 2B is a schematic view of the line of action.

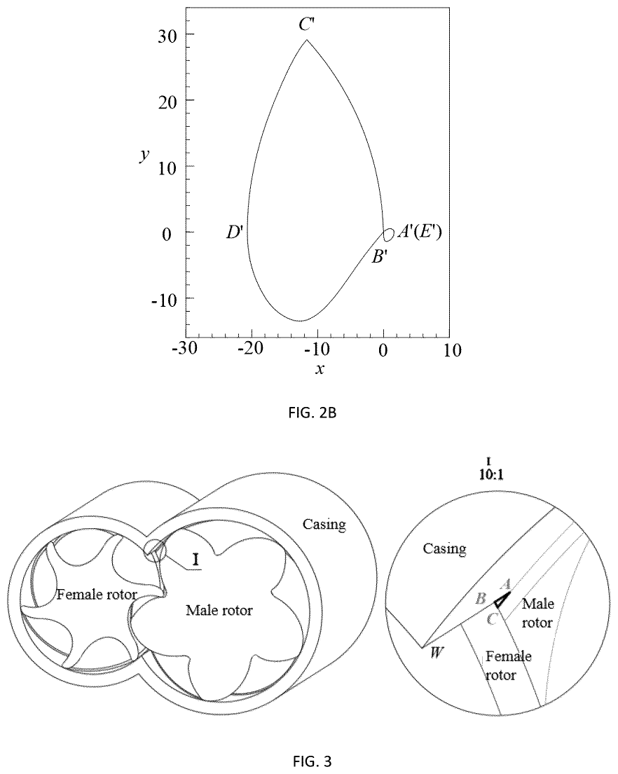

Usually, the highest point of the contact line between the female and male rotors of the twin-screw compressor (as shown in the point C in FIG. 3) cannot reach an intersection line (WW) of cylindrical surfaces on the inner wall of the casing, so the intersection line of the cylindrical surfaces on the inner wall of the casing and the tooth flanks of the female and male rotors will form a spatial curved edge triangle leakage region which is referred to as a leakage triangle. As shown in ΔABC in FIG. 3, the point A is an intersection point between the tooth flank of the male rotor and an intersection line WW of the inner wall surface of the casing, the point B is an intersection point between the tooth flank of the female rotor and the intersection line WW of the inner wall surface of the casing, and the point C is the highest point of the contact line. The leakage triangle is also a channel connecting two adjacent cell volumes, and the gas on the high-pressure side will leak to the low-pressure side through the leakage triangle, resulting in internal axial leakage. The right figure in FIG. 3 is an enlarged view of a part I circled in the left figure.

Computation of Leakage Triangle Area:

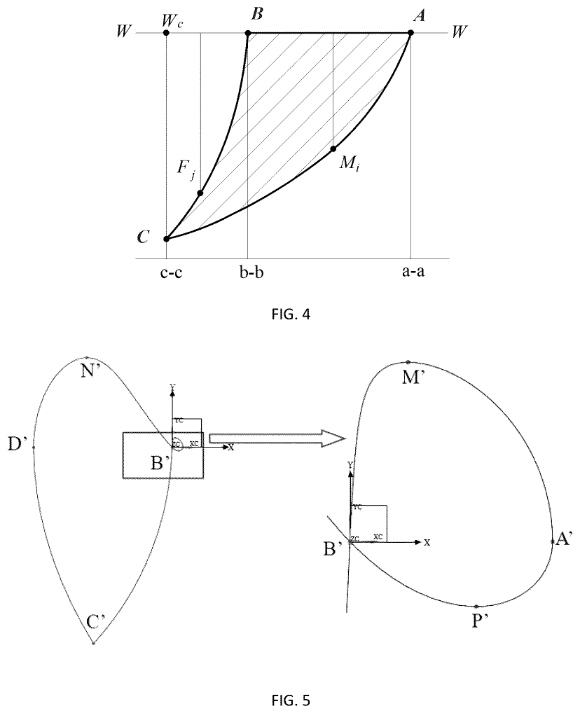

From the perspective of the rotor end plane, it is generally believed that the farther the highest point C of the line of action is from the end point W of the intersection line of the inner wall surface of the casing, the larger the leakage triangle area, and the more severe the internal axial leakage. The leakage triangle area is the area of the spatial curved edge triangle ΔABC. A plane is made through the intersection line WW of the cylindrical surfaces on the inner wall of the casing and the highest point C of the line of action, and the curved edge triangle A ABC is projected onto the plane, as shown in FIG. 4. The leakage triangle area may be expressed as:

ΔS_{ABC}=ΔS_{ACW}_{_{C}}−ΔS_{BCW}_{_{C}} (2)

For the convenience of computation, curves AC and BC are discretized into p points and q points respectively. The more the discrete points there are, the more accurate the computation result will be. Points Mᵢ and Fⱼ are set as discrete points on the curves AC and BC respectively and the distances between the points Mᵢ and Fⱼ and the intersection line WW are set as W̅M̅ᵢ and W̅F̅ⱼ respectively, then:

$$Δ {S}_{{ACW}_{C}} = {\sum }_{i = 1}^{p} \frac{\overline{AB}}{p} \cdot \overline{{WM}_{ι}} , \qquad ( 3 )$$

$$Δ {S}_{{BCW}_{C}} = {\sum }_{j = 1}^{q} \frac{\overline{{BW}_{C}}}{q} \cdot \overline{{WF}_{}} . \qquad ( 4 )$$

Therefore, the leakage triangle area may be expressed as:

$$S = Δ {S}_{ABC} = {\sum }_{i = 1}^{p} \frac{\overline{AB}}{p} \cdot \overline{{WM}_{ι}} - {\sum }_{j = 1}^{q} \frac{\overline{{BW}_{C}}}{q} \cdot \overline{{WF}_{}} . \qquad ( 5 )$$

The inter-tooth area is a projection of the cell volume on the rotor end plane. The shaded portions 6 and 9 in FIG. 1 represent the inter-tooth area of the male rotor and the inter-tooth area of the female rotor respectively, and the inter-tooth area directly reflects the cell volume.

A parameter equation of a certain segment of tooth curve AB in the rotor profile is known:

$$\{ \begin{matrix}u = u ( t ) \\ v = v ( t )\end{matrix} {t}_{s} < t < {t}_{e} . \qquad ( 6 )$$

Usually, during optimization design of the rotor profile, a decrease in the inter-tooth area of the male rotor may lead to an increase in the inter-tooth area of the female rotor. Therefore, in order to more vividly describe and quantify the changes in the inter-tooth areas of the female and male rotors before and after optimization design, the area utilization coefficient Cₐ is introduced to represent the utilization degree within the range of the tip circle of the twin-screw rotor.

The computation process of the area utilization coefficient Cₐ is as follows:

An inter-tooth area A₀₂ and an inter-tooth area A₀₁ of the female and male rotors are computed respectively. The inter-tooth area refers to an area of a projection of a relatively closed cell volume formed between helical tooth flanks of the female and male rotors and the casing on the rotor end plane when the two rotors rotate and mesh.

After the inter-tooth area A₀₂ and the inter-tooth area A₀₁ of the female and male rotors are computed, the area utilization coefficient Cₐ is computed according to Formula (9):

$${C}_{α} = \frac{{z}_{1} ( {A}_{01} + {A}_{02} )}{{D}_{1}^{2}} , \qquad ( 9 )$$

where D₁ represents a tip diameter of the male rotor, and z₁ represents a number of teeth of the male rotor.

When the inter-tooth area A₀₂ and the inter-tooth area A₀₁ of the female and male rotors are computed, the following method may be used:

A two-dimensional coordinate system is established with the center of the male rotor as an origin O, the direction from the center of the female rotor to the center of the male rotor as a U axis, and the U axis rotating 90° counterclockwise on an end plane as a V axis.

A parameter equation of a certain segment of tooth curve in the rotor profile is obtained:

$$\{ \begin{matrix}u = u ( t ) \\ v = v ( t )\end{matrix} {t}_{s} < t < {t}_{e} ,$$

where the tooth curve refers to a segment of profile curve corresponding to female and male rotor profiles.

The rotor profile is composed of g segments of tooth curves, the inter-tooth area corresponding to each segment of tooth curve of the female and male rotors is computed respectively according to the number of rotor teeth of the female and male rotors and the tip radius, and then, the inter-tooth areas are accumulated and summed to obtain complete inter-tooth areas A₀₂ and A₀₁ of the female and male rotors.

The inter-tooth areas of the female and male rotors are computed according to Formula (7) and Formula (8):

$${A}_{02} = \frac{π {R}_{2}^{2}}{{z}_{2}} - \frac{1}{2} {\sum }_{i = 1}^{g} {\int }_{{t}_{s i}}^{{t}_{e i}} ( {u}_{2 i} {v}_{2 i}^{′} - {u}_{2 i}^{′} {v}_{2 i} ) dt , \qquad ( 7 )$$

$${A}_{01} = \frac{π {R}_{1}^{2}}{{z}_{1}} - \frac{1}{2} {\sum }_{i = 1}^{g} {\int }_{{t}_{s i}}^{{t}_{e i}} ( {u}_{1 i} {v}_{1 i}^{′} - {u}_{1 i}^{′} {v}_{1 i} ) dt , \qquad ( 8 )$$

where z represents a number of rotor teeth, R represents a tip radius, g represents a number of tooth curve, subscripts 2 and 1 represent female and male rotors respectively, u and v represent variables on a tooth curve equation, u′ and v′ represent first derivatives, and is and to represent a value interval of a parameter t.

It should be noted that the above only lists a method for computing inter-tooth areas of female and male rotors, and inter-tooth areas may also be obtained by other known methods which are not limited in this application.

It can be seen from Formula (9) that when the tip diameter is constant, the larger the inter-tooth area, the greater the area utilization coefficient, that is, the higher the overall utilization degree of the rotor profile within the range of the tip circle. Table 1 shows the value of the area utilization coefficient Cₐ of common rotor profiles.

TABLE 1
Area utilization coefficient of common rotor profiles

| | | Unilateral | | | | | | |
|---|---|---|---|---|---|---|---|---|
| | | asymmetric | | | | | | |
| | Bilateral | cycloid- | | | | | | |
| | symmetric | pin tooth | | | | | | |
| Rotor | arc | arc | Atlas-x | SRM-A | GHH | Fusheng | SRM-D | Hitachi |
| profile | profile | profile | profile | profile | profile | profile | profile | profile |
| Area | 0.4889 | 0.4696 | 0.4856 | 0.5009 | 0.4495 | 0.4474 | 0.4979 | 0.4013 |
| utilization | | | | | | | | |
| coefficient | | | | | | | | |

Step 2: The rotor line of action after segmenting is adjusted, and the value of each performance parameter of the adjusted rotor profile is computed. The performance parameters include a contact line length L, a leakage triangle area S and an area utilization coefficient Cₐ.

As shown in FIG. 5, each point on the line of action of the twin-screw rotor is determined in a clockwise direction, and the line of action is divided into eight segments through each point. A point A′ is an intersection point of a tip circle of the female rotor and a root circle of the male rotor, a point B′ is an intersection point of pitch circles of the female and male rotors, a point C′ is a bottom dead center of the line of action, and a point D′ is an intersection point of a tip circle of the male rotor and a root circle of the female rotor. Then, an arc A′B′, an arc D′B′ and an arc B′A′ are divided into left and right segments with the lowest point P′ of the arc A′B′, the highest point N′ of the arc D′B′ and the highest point M′ of the arc B′A′ as boundaries.

The line of action is a “∞”-shaped pattern with a great difference in sizes of circles on left and right sides, so the figure on the left side in FIG. 5 shows an overall view of the line of action, and the figure on the right side in FIG. 5 shows an enlarged view of the part boxed in the figure on the left side.

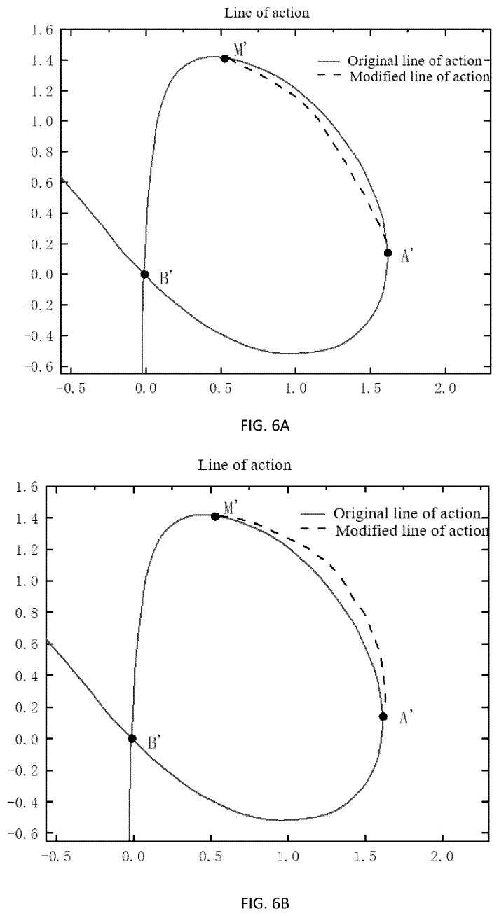

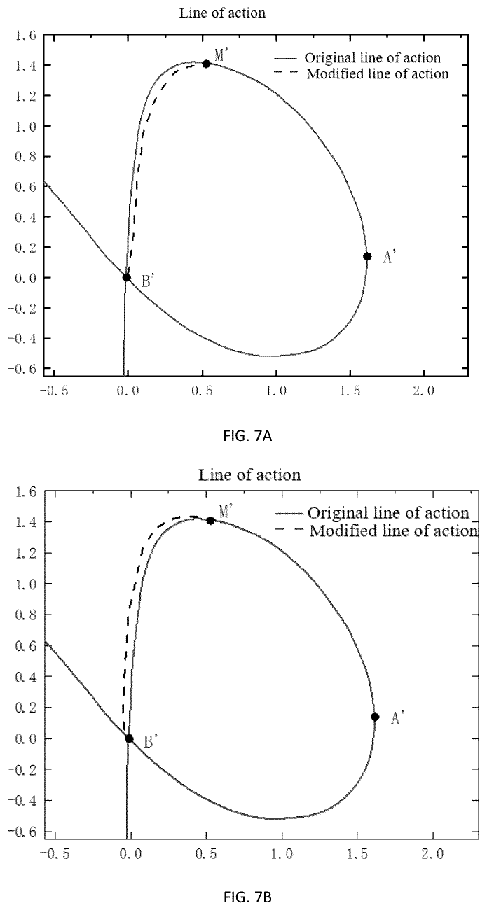

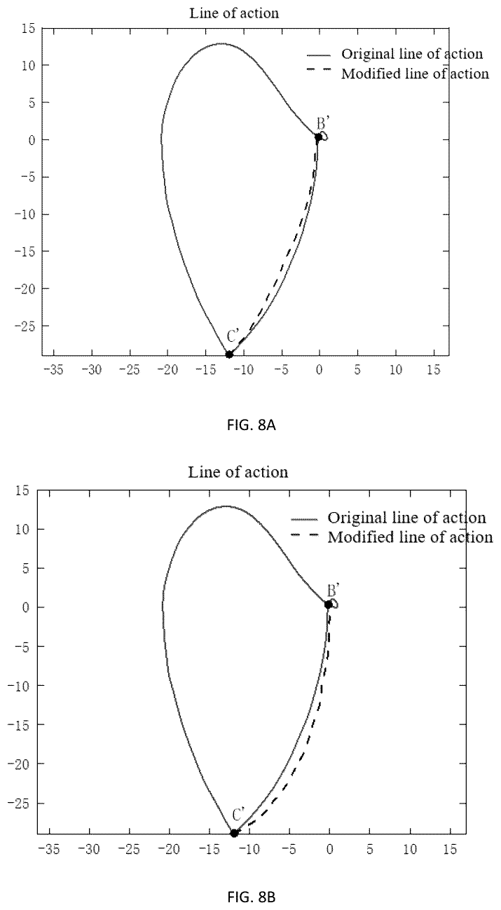

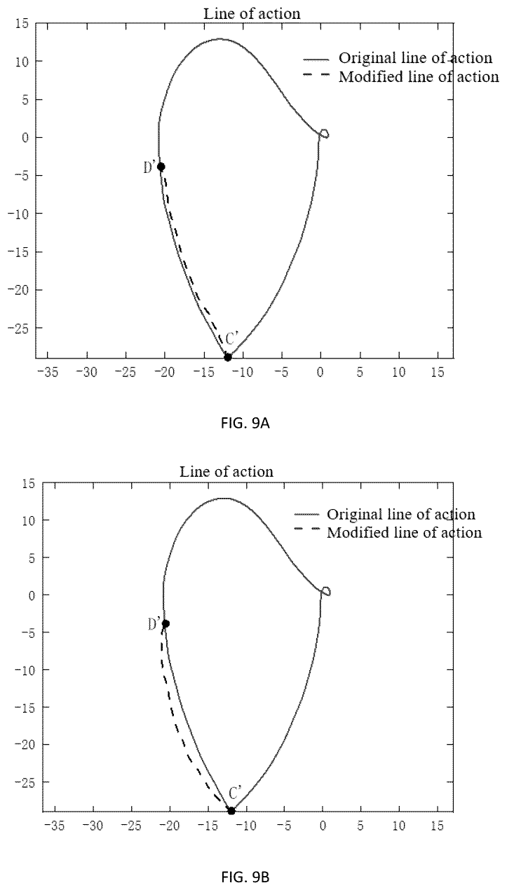

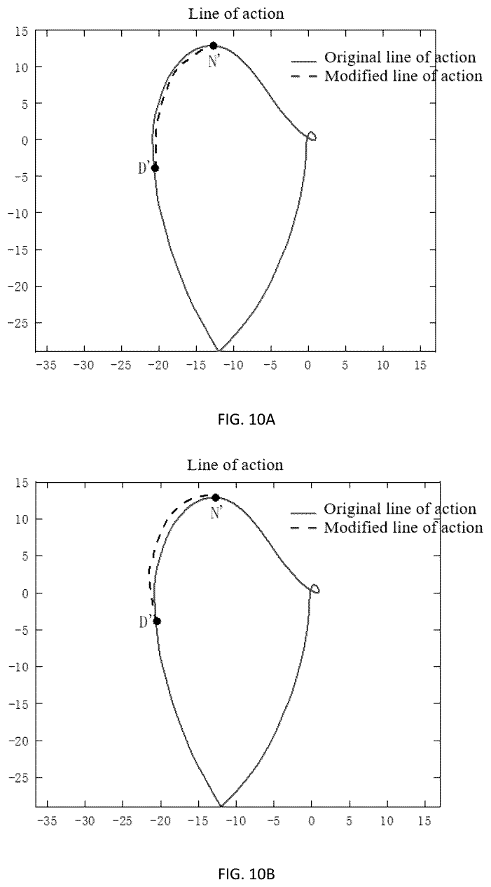

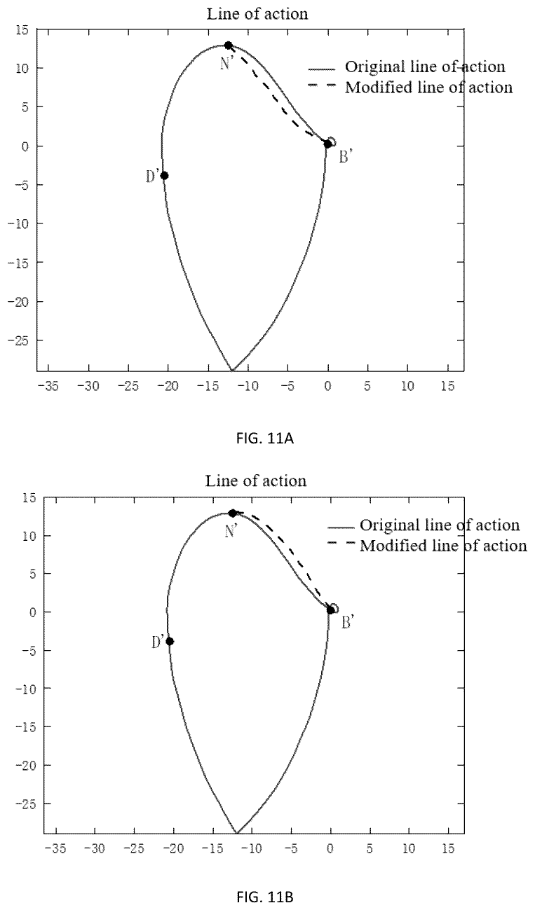

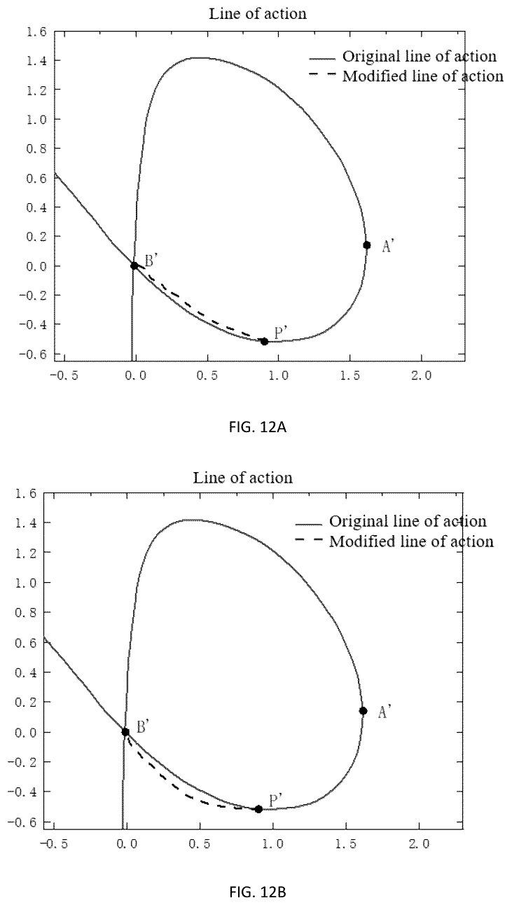

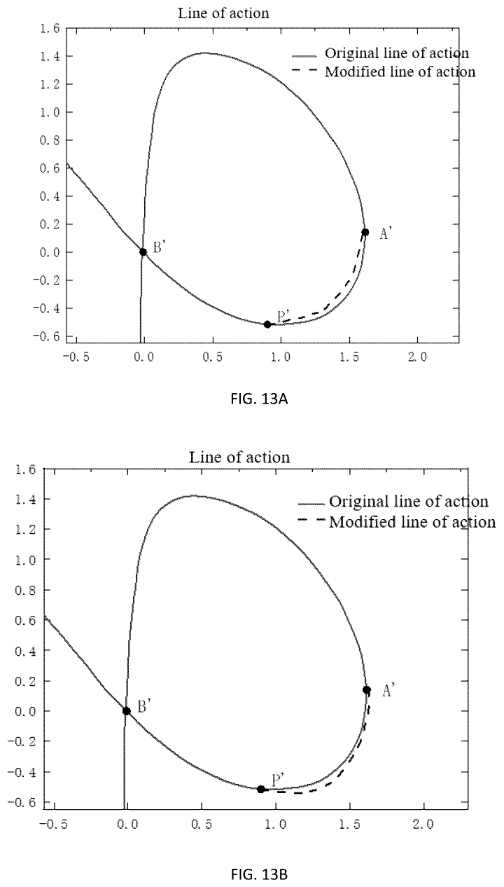

In this application, it is specified that the modification direction that reduces the area enclosed by the line of action is “inside”, otherwise it is “outside”. Each segment of line of action is adjusted “inside” or “outside” respectively. The adjustment of each segment of line of action is shown in FIG. 6 to FIG. 13B. The value of each performance parameter of the adjusted rotor profile is computed, as shown in Table 2.

For the convenience of computation of parameters in Table 2, parameter values may be directly computed or by a TSPD program, or parameter values before and after adjustment may be recorded respectively by an Excel table. For the introduction of the TSPD program, reference may be made to “Shi Guojiang, He Xueming, & Zhang Rong. (2018). Research on Development of the Design System of Twin Screw Compressor Rotor Profiles. Compressor Technology, (5), 6-13.”

TABLE 2
Impact of each segment of line of action on performance parameters of
rotor (↓ represents decrease, ↑ represents increase)

| | | | Contact | Leakage | Area |
|---|---|---|---|---|---|
| Line of | | Adjustment | line | triangle | utilization |
| action segment | | direction | length/mm | area/mm² | coefficient |
| Original line | | / | 149.7877 | 5.1925 | 0.4597 |
| of action | | | | | |
| A′B′ | A′M′ | Inside | 151.6907↑ | 5.0707↓ | 0.4561↓ |
| | | Outside | 150.5651↑ | 5.6112↑ | 0.4627↑ |
| | M′B′ | Inside | 151.7859↑ | 5.1814↓ | 0.4596↓ |
| | | Outside | 149.9834↑ | 5.2015↑ | 0.4598↑ |
| B′C′ | | Inside | 149.8646↑ | 5.1497↓ | 0.4548↓ |
| | | Outside | 151.8018↑ | 5.3372↑ | 0.4617↑ |
| C′D′ | | Inside | 149.5676↓ | 4.9460↓ | 0.4467↓ |
| | | Outside | 150.2501↑ | 5.2864↑ | 0.4729↑ |
| D′B′ | D′N′ | Inside | 149.2576↓ | 5.1925 | 0.4406↓ |
| | | Outside | 152.9892↑ | 5.1925 | 0.4753↑ |
| | N′B′ | Inside | 150.4655↑ | 5.1925 | 0.4500↓ |
| | | Outside | 149.2638↓ | 5.1925 | 0.4685↑ |
| B′A′ | B′P′ | Inside | 154.5387↑ | 5.1925 | 0.4578↓ |
| | | Outside | 151.3217↑ | 5.1925 | 0.4619↑ |
| | P′A′ | Inside | 152.2962↑ | 5.1925 | 0.4533↓ |
| | | Outside | 149.9287↑ | 5.1925 | 0.4631↑ |

It can be seen from Table 2 the following:

(1) When the area enclosed by the line of action increases, the inter-tooth area utilization coefficient increases, that is, the sum of the inter-tooth areas of the female and male rotors increases.

(2) When only the segment A′B′, segment B′C′ and segment C′D′ of the line of action have an impact on the leakage triangle area and all move towards the inside of the original line of action, the leakage triangle area decreases, and at this time, the area utilization coefficient also decreases, thus forming a mutual impact relationship.

(3) The above performance parameters have different directions of impact on the performance of the compressor, so the design quality of the rotor profile cannot be determined according to one of the parameters. Therefore, this application proposes a comprehensive performance index to make a reasonable evaluation for the quality of the rotor profile. A relational expression of a comprehensive performance index for evaluating the performance of a compressor rotor is established as follows:

K=aL*bS/(cCₐ) (10),

where
L—contact line length, mm
S—leakage triangle area, mm²
Cₐ—area utilization coefficient.

Step 3: Coefficients of performance parameters in the relational expression of the comprehensive performance index are determined. The contact line length is about 150 mm, the leakage triangle area is about 5 mm², the inter-tooth area of the male rotor is about 610 mm², and the inter-tooth area of the female rotor is about 620 mm², so the area utilization coefficient is about 0.45. Assuming that a=0.01, b=1, and c=10, L and Cₐ are unified to the order of magnitude of S.

Step 4: A relational expression of a comprehensive performance index K of the performance of the compressor rotor is determined according to step 1 to step 3. According to the coefficients of the parameters in step 3, the relational expression of the comprehensive performance index K is obtained as follows:

K=0.01L*S/(10*Cₐ) (11).

By the computation of a design system for a rotor profile of a twin-screw compressor, the contact line length L=148.146 mm, the leakage triangle area S=4.2588 mm², and the area utilization coefficient Cₐ=0.4542, so the comprehensive performance index K_{orginal}=1.3891. The six-time NURBS-fitted Fusheng line of action is optimized now.

Each segment is adjusted respectively by the same method. The obtained performance parameters of the rotor profile and the comprehensive performance index are as shown in Table 3.

TABLE 3
Impact of line of action on comprehensive performance index

| | | | Contact | Leakage | Area | |
|---|---|---|---|---|---|---|
| | | | line | triangle | utilization | Comprehensive |
| Line of | | Adjustment | length | area | coefficient | performance |
| action segment | | direction | L (mm) | S (mm²) | C_{α} | index K |
| Original line of | | / | 148.1460 | 4.2588 | 0.4542 | 1.3891 |
| action | | | | | | |
| A′B′ | A′M′ | Inside | 148.0517↓ | 4.5293↑ | 0.4518↓ | 1.4842↑ |
| | A′M′ | Outside | 148.0789↓ | 4.1202↓ | 0.4550↑ | 1.3409↓ |
| | M′B′ | Inside | 148.2455↑ | 4.3001↑ | 0.4542↓ | 1.4035↑ |
| | M′B′ | Outside | 148.0783↓ | 4.2300↓ | 0.4543↑ | 1.3788↓ |
| B′C′ | | Inside | 148.2440↑ | 4.6982↑ | 0.4540↓ | 1.5341↑ |
| | | Outside | 148.1553↑ | 4.0426↓ | 0.4544↑ | 1.3181↓ |
| C′D′ | | Inside | 147.9422↓ | 4.0271↓ | 0.4483↓ | 1.3290↓ |
| | | Outside | 148.3603↑ | 4.6849↑ | 0.4602↑ | 1.5103↑ |
| D′B′ | D′N′ | Inside | 150.4533↑ | 4.2588 | 0.3937↓ | 1.6275↑ |
| | D′N′ | Outside | 148.0072↓ | 4.2588 | 0.4648↑ | 1.3561↓ |
| | N′B′ | Inside | 148.2254↑ | 4.2588 | 0.4522↓ | 1.3960↑ |
| | N′B′ | Outside | 148.0427↓ | 4.2588 | 0.4562↑ | 1.3820↓ |
| B′A′ | B′P′ | Inside | 148.6028↑ | 4.2588 | 0.4538↓ | 1.3946↑ |
| | B′P′ | Outside | 148.7856↑ | 4.2588 | 0.4547↑ | 1.3936↑ |
| | P′A′ | Inside | 148.5209↑ | 4.2588 | 0.4492↓ | 1.4081↑ |
| | P′A′ | Outside | 147.9897↓ | 4.2588 | 0.4567↑ | 1.3800↓ |

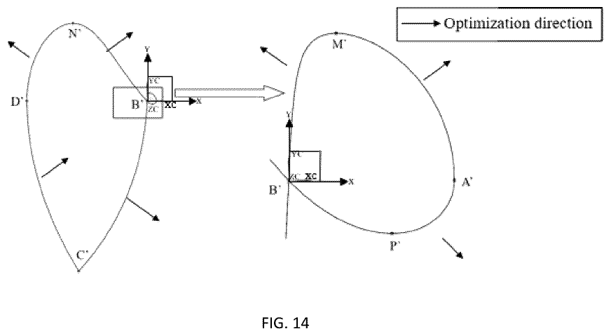

According to Table 3, the mode for adjusting each segment to improve the comprehensive performance of the profile is: A′M′ is outward, M′B′ is outward, B′C′ is outward, C′D′ is inward, D′N′ is outward, N′B′ is outward, B′P′ is unchanged, and P′A′ is outward. As shown in FIG. 14, the figure on the left side in FIG. 14 shows the adjustment direction of each segment on the circle on the left side of the line of action, and the figure on the right side in FIG. 14 shows the adjustment direction of each segment on the circle on the right side of the line of action.

After each segment is optimized respectively, the optimized segments may be integrated into a complete line of action, and an optimized profile is generated according to the line of action. Performance parameters of the optimized profile are shown in Table 4. Compared with the original profile, the optimized profile has the following changes: The contact line length is slightly increased by 0.6306 mm, which is relatively increased by 0.3%. The leakage triangle region area is reduced by 0.3317 mm², which is relatively reduced by 7.8%. The area utilization coefficient is increased by 0.0325, which is relatively increased by 7.2%. The value of the comprehensive performance index K is relatively reduced by 13.66%, that is, the sealing performance of the rotor profile is optimized by 13.66%.

TABLE 4
Comparison of performance parameters between
original profile and optimized profile

| | Contact | Leakage | Area | |
|---|---|---|---|---|
| | line | triangle | utilization | Comprehensive |
| | length | area S | coefficient | performance |
| | L (mm) | (mm²) | C_{α} | index K |
| Original | 148.146 | 4.2588 | 0.4542 | 1.3891 |
| profile | | | | |
| Optimized | 148.6452 | 3.9271 | 0.4867 | 1.1993 |
| profile | | | | |
| Amplification | 0.6306 | −0.3317 | 0.0325 | −0.1898 |
| Amplification | 0.3% | −7.8% | 7.2% | −13.66% |
| ratio | | | | |

By the method for optimizing a twin-screw rotor profile provided in this application, the design efficiency of the twin-screw rotor profile is greatly improved, and the twin-screw rotor produced according to the optimized rotor profile subsequently can make the performance of the compressor better.

Some steps in the examples of the disclosure may be implemented by software, and corresponding software programs may be stored in a readable storage medium, such as an optical disk or a hard disk.

The above examples are merely preferred examples of the disclosure and are not intended to limit the disclosure. Any modification, equivalent replacement and improvement made within the spirit and principle of the disclosure are intended to be included within the protection scope of the disclosure.

What is claimed is:

1. A method for optimizing a twin-screw rotor profile, comprising:
obtaining relevant parameters of female and male rotors of a twin-screw rotor: a contact line length L, a leakage triangle area S, a number of rotor teeth of the female and male rotors, and a tip radius;
computing an area utilization coefficient Cₐ according to the number of rotor teeth of the female and male rotors and the tip radius;
computing a comprehensive performance index K according to Formula (10):
K=aL*bS/(cCₐ) (10),
wherein a, b and c are coefficients that unify the contact line length L and the area utilization coefficient Cₐ to the order of magnitude of the leakage triangle area S;
determining each point on a line of action of the twin-screw rotor in a clockwise direction to divide the line of action into eight segments, wherein a point A′ is an intersection point of a tip circle of a female rotor of the female and male rotors and a root circle of a male rotor of the female and male rotors, a point B′ is an intersection point of pitch circles of the female and male rotors, a point C′ is a bottom dead center of the line of action, and a point D′ is an intersection point of a tip circle of the male rotor and a root circle of the female rotor; then, dividing an arc A′B′, an arc D′B′ and an arc B′A′ into left and right segments with the lowest point P′ of the arc A′B′, the highest point N′ of the arc D′B′ and the highest point M′ of the arc B′A′ as boundaries;
adjusting the line of action of each of the segments separately “inside” or “outside” respectively, and determining the adjustment direction and distance of each of the segments by computing a comprehensive performance index K of the twin-screw rotor profile before and after adjustment, wherein a modification direction that reduces the area enclosed by the line of action is “inside”, otherwise it is “outside”; and
determining a twin-screw rotor profile with a minimum comprehensive performance index K, namely an optimized twin-screw rotor profile, based on the adjustment direction and distance of each of the segments, so as to facilitate the subsequent preparation of a screw rotor of a screw compressor according to the optimized twin-screw rotor profile.

2. The method according to claim 1, wherein the determining the adjustment direction and distance of each of the segments by computing a comprehensive performance index K of the twin-screw rotor profile before and after adjustment comprises:
if a value of the comprehensive performance index K of the twin-screw rotor profile after adjustment is less than a value before adjustment, continuing to perform adjustment in the current direction until the value of the comprehensive performance index K reaches an inflection point; and
if the value of the comprehensive performance index K of the twin-screw rotor profile after adjustment is greater than the value before adjustment, performing adjustment in the opposite direction until the value of the comprehensive performance index K reaches an inflection point.

3. The method according to claim 1, wherein the computing an area utilization coefficient Cₐ according to the number of rotor teeth of the female and male rotors and the tip radius comprises:
computing an inter-tooth area A₀₂ and an inter-tooth area A₀₁ of the female and male rotors respectively, wherein the inter-tooth area refers to an area of a projection of a relatively closed cell volume formed between helical tooth flanks of the female and male rotors and a casing on a rotor end plane when the female and male rotors rotate and mesh; and
computing the area utilization coefficient Cₐ according to Formula (9):
$${C}_{α} = \frac{{z}_{1} ( {A}_{01} + {A}_{02} )}{{D}_{1}^{2}} , \qquad ( 9 )$$
wherein D₁ represents a tip diameter of the male rotor, and z₁ represents a number of teeth of the male rotor.

5. The method according to claim 1, wherein when the units of the contact line length L, the number of rotor teeth of the female and male rotors and the tip radius are millimeter and the unit of the leakage triangle area S is square millimeter, values of a, b and c are respectively:
a=0.01, b=1, c=10.

6. The method according to claim 1, wherein when obtaining the contact line length L, the method comprises:
establishing a three-dimensional coordinate system with an axial center of an end plane of the male rotor as an origin O, a direction pointing to an axial center of the female rotor as an X axis, an axial direction as a Z axis, and a Y axis perpendicular to an XOZ plane; and
discretizing the contact line into m points, and computing the contact line length L according to Formula (1):
L=Σₙ₌₁^{m}\sqrt{(xₙ−xₙ₋₁)²+(yₙ−yₙ₋₁)²+(zₙ−zₙ₋₁)²} (1),
wherein n represents a subscript of each of the discrete points, n=1, 2, . . . , m, and xₙ, yₙ and zₙ represent three-dimensional coordinates of each of the discrete points.

7. The method according to claim 1, wherein when obtaining the leakage triangle area S, the method comprises:
setting a point A as an intersection point between a tooth flank of the male rotor and an intersection line WW of an inner wall surface of a casing, a point B as an intersection point between a tooth flank of the female rotor and the intersection line WW of the inner wall surface of the casing, and a point C as the highest point of the contact line of the twin-screw rotor, wherein the contact line is a curve formed in space by a contact part between two helical tooth flanks when the female and male rotors mesh;
discretizing curves AC and BC into p points and q points respectively; and
setting points Mᵢ and Fⱼ as discrete points on the curves AC and BC respectively and the distances between the points Mᵢ and Fⱼ and the intersection line WW as W̅M̅ᵢ and W̅F̅ⱼ respectively, obtaining:
$$Δ {S}_{{ACW}_{C}} = {\sum }_{i = 1}^{p} \frac{\overline{AB}}{p} \cdot \overline{{WM}_{ι}} , \qquad ( 3 )$$
$$Δ {S}_{{BCW}_{C}} = {\sum }_{j = 1}^{q} \frac{\overline{{BW}_{C}}}{q} \cdot \overline{{WF}_{}} , \qquad ( 4 )$$
and obtaining the leakage triangle area S:
$$S = Δ {S}_{ABC} = {\sum }_{i = 1}^{p} \frac{\overline{AB}}{p} \cdot \overline{{WM}_{ι}} - {\sum }_{j = 1}^{q} \frac{\overline{{BW}_{C}}}{q} \cdot \overline{{WF}_{}} , \qquad ( 5 )$$
wherein A̅B̅ represents an edge projected onto the intersection line WW by a curved edge AB of a spatial curved edge leakage triangle, and B̅W̅_{c} represents a distance between a projection point of the highest point of the contact line on the intersection line WW and the point B.

8. The method according to claim 1, wherein the line of action is a projection of the contact line on an axial end plane of the rotor.

9. The method according to claim 1, wherein the area enclosed by the line of action refers to an area of a closed region enclosed by the line of action.

10. A method for judging the comprehensive performance of a twin-screw rotor profile, comprising:
obtaining relevant parameters of female and male rotors of a twin-screw rotor: a contact line length L, a leakage triangle area S, a number of rotor teeth of the female and male rotors, and a tip radius;
computing an area utilization coefficient Cₐ according to the number of rotor teeth of the female and male rotors and the tip radius;
computing a comprehensive performance index K according to Formula (10):
K=aL*bS/(cCₐ) (10),
wherein a, b and c are coefficients that unify the contact line length L and the area utilization coefficient Cₐ to the order of magnitude of the leakage triangle area S; and
judging the performance of the twin-screw rotor profile according to the computed value of the comprehensive performance index K.

11. The method according to claim 10, wherein when the units of the contact line length L, the number of rotor teeth of the female and male rotors and the tip radius are millimeter and the unit of the leakage triangle area S is square millimeter, values of a, b and c are respectively:
a=0.01, b=1, c=10.

12. The method according to claim 10, wherein the computing an area utilization coefficient Cₐ according to the number of rotor teeth of the female and male rotors and the tip radius comprises:
computing an inter-tooth area A₀₂ and an inter-tooth area A₀₁ of the female and male rotors respectively, wherein the inter-tooth area refers to an area of a projection of a relatively closed cell volume formed between helical tooth flanks of the female and male rotors and a casing on a rotor end plane when the two rotors rotate and mesh; and
computing the area utilization coefficient Cₐ according to Formula (9):
$${C}_{α} = \frac{{z}_{1} ( {A}_{01} + {A}_{02} )}{{D}_{1}^{2}} , \qquad ( 9 )$$
wherein D₁ represents a tip diameter of the male rotor, and z₁ represents a number of teeth of the male rotor.

13. The method according to claim 10, wherein when obtaining the contact line length L, the method comprises:
establishing a three-dimensional coordinate system with an axial center of an end plane of the male rotor as an origin O, a direction pointing to an axial center of the female rotor as an X axis, an axial direction as a Z axis, and a Y axis perpendicular to an XOZ plane; and
discretizing the contact line into m points, and computing the contact line length L according to Formula (1):
L=Σₙ₌₁^{m}\sqrt{(xₙ−xₙ₋₁)²+(yₙ−yₙ₋₁)²+(zₙ−zₙ₋₁)²} (1),
wherein n represents a subscript of each of the discrete points, n=1, 2, . . . , m, and xₙ, yₙ and zₙ represent three-dimensional coordinates of each of the discrete points.

14. The method according to claim 10, wherein when obtaining the leakage triangle area S, the method comprises:
setting a point A as an intersection point between a tooth flank of the male rotor and an intersection line WW of an inner wall surface of a casing, a point B as an intersection point between a tooth flank of the female rotor and the intersection line WW of the inner wall surface of the casing, and a point C as the highest point of the contact line of the twin-screw rotor, wherein the contact line is a curve formed in space by a contact part between two helical tooth flanks when the female and male rotors mesh;
discretizing curves AC and BC into p points and q points respectively; and
setting points Mᵢ and Fⱼ as discrete points on the curves AC and BC respectively and the distances between the points Mᵢ and Fⱼ and the intersection line WW as W̅M̅ᵢ, and W̅F̅ⱼ respectively, obtaining:
$$Δ {S}_{{ACW}_{C}} = {\sum }_{i = 1}^{p} \frac{\overline{AB}}{p} \cdot \overline{{WM}_{ι}} , \qquad ( 3 )$$
$$Δ {S}_{{BCW}_{C}} = {\sum }_{j = 1}^{q} \frac{\overline{{BW}_{C}}}{q} \cdot \overline{{WF}_{}} , \qquad ( 4 )$$
and obtaining the leakage triangle area S:
$$S = Δ {S}_{ABC} = {\sum }_{i = 1}^{p} \frac{\overline{AB}}{p} \cdot \overline{{WM}_{ι}} - {\sum }_{j = 1}^{q} \frac{\overline{{BW}_{C}}}{q} \cdot \overline{{WF}_{}} , \qquad ( 5 )$$
wherein A̅B̅ represents an edge projected onto the intersection line WW by a curved edge AB of a spatial curved edge leakage triangle, and B̅W̅_{c} represents a distance between a projection point of the highest point of the contact line on the intersection line WW and the point B.
